(19) United States
(12) Patent Application Publication
(10) Pub. No.: US 2017/0133180 A1
(43) Pub. Date: May 11, 2017

(54) Rotary Contact System Intended to be Incorporated into the Tubular Conductors of a High-Voltage Switch

(71) Applicant: Mikhail SOTNIKOV, Saint Bruno (CA)

(72) Inventor: Mikhail SOTNIKOV, Saint Bruno (CA)

(21) Appl. No.: 15/303,129

(22) PCT Filed: Apr. 22, 2015
(86) PCT No.: PCT/CA2015/050338

§ 371 Date: Oct. 10, 2016

(30) Foreign Application Priority Data
Apr. 24, 2014 (MX) MX/A/2014/004937

(51) Int. Cl. H01H 33/02; H01H 1/50; H01H 31/30

(52) U.S. Cl. CPC H01H 33/025; H01H 31/30; H01H 1/50

(57) ABSTRACT

The present invention relates to electrical devices, and more specifically to movable contact assemblies that are used in a high-voltage switch, such as a rotary contact system intended to be incorporated into the tubular conductors of a high-voltage switch, which includes: a main pin; a first assembly, consisting of a primary tubular conductor and a male cylindrical conductor; a second assembly, consisting of a secondary fitting, a secondary conductor, and a female cylindrical conductor, with the said second assembly being coupled rotatively to the first assembly by means of the main pin.

### CROSS REFERENCE TO RELATED APPLICATIONS

This application is the National Stage entry in the United States of International Application No. PCT/CA2015/050338 filed Apr. 22, 2015, which claims the priority and benefit of Mexican Patent Application No. MX/a/2014/004937 filed Apr. 24, 2014, the entireties of which are incorporated herein by reference.

### FIELD OF THE INVENTION

This invention relates to electrical devices, and more specifically to movable contact assemblies that are used in high-voltage switches.

### BACKGROUND OF THE INVENTION

High-voltage switches are essential devices in an electrical power grid, and are designed to isolate different sections of the electrical grid. In order to create a physical separation between two poles, the switches perform various movements.

For high-voltage switches, the movement takes place by means of the rotation of a pole isolator. Various devices for performing this movement are currently available on the market. However, they pose problems of wear and poor conductivity. The present invention seeks to solve the technical problems of wear and poor conductivity, as well as other problems that are present.

The presence of movement in a switch requires the use of movable electrical contacts in the construction of the devices. The movement of the electrical contacts in the switches takes the form of rotation or displacement. The electrical contacts can operate with or without the interruption of the physical link.

A high-voltage switch is constructed with rounded tubular conductors in order to reduce overheating and energy loss, and in order to provide a switch with light construction or low weight. The individual resistances of some of the components used in switch construction, and the resistance of the contact interfaces, play a crucial role in the normal operation of the equipment.

Ideal movable electrical contact systems must have a minimum number of contact interfaces; low transition resistance; low pressure force; no contact wear; a high current rating and short-circuit capacity; corrosion-resistant construction; the ability to withstand thermal cycling; the ability to accommodate misalignments; low weight; and the ability to be easily inspected and replaced.

The first goal of the invention is to provide a high-voltage disconnect switch with a rotary contact assembly and with a minimal number of contact interfaces.

The use of contacts with a reduced aluminum section that are installed perpendicularly directly into the primary conductor allows the construction of a rotary assembly through the use of only four conductive elements.

Electrical contacts with spring bushings that have a reduced aluminum section will have a safe material section and the contact pressure necessary for the transfer of the rated electrical current. they will allow the electrical equipment to withstand higher short-circuit ranges while maintaining contact pressure afterward.

Another goal of the invention is to provide electrical switching devices with electrical contacts that include spring bushings with a reduced aluminum section, with a pre-installation feature that uses grooved contact surfaces and avoids multiple bolted assemblies, in order to achieve low interface resistance.

Another goal of the invention is to provide electrical contacts that include spring bushings with a reduced aluminum section that can be installed directly on tubular conductors with no additional electrical or mechanical parts, while reducing the number of electrical interfaces in the electrical switching device.

Another goal of the invention is to provide electrical contacts with a low operating force.

Another goal of the invention is to provide an electrical contact assembly with a fixed contact-interface area or zone.

Another goal of the invention is to provide an electrical contact assembly with two contact parts that can easily be disassembled.

Another goal of the invention is to provide electrical contacts with a spring bushing with a reduced aluminum section, with the ability to achieve all of the necessary contact pressure solely from the plastic deformation of the aluminum, and without depending on the partial pressure of the elastic deformation of the copper extensions or fingers.

Another goal of the invention is to provide electrical contacts with a spring bushing with a reduced aluminum section that uses the mechanical properties of the aluminum as an element to transfer the pressure to the contact assembly.

Another goal of the invention is to provide electrical contacts with a spring bushing (3) with a reduced aluminum section, with a compact design and a reduced space requirement, for incorporation into electrical switching devices.

Another goal of the invention is to provide electrical contacts with a spring bushing with a reduced aluminum section, with simple construction consisting of three components (i.e., a male cylindrical conductor, a spring bushing with a reduced aluminum section, and a female cylindrical conductor).

Another goal of the invention is to provide electrical contacts with a spring bushing with a reduced aluminum section, and with stable contact pressure and the ability to adapt to the mechanical wear of the contacts.

Another goal of the invention is to provide electrical contacts with a spring bushing with a reduced aluminum section, with a clearly defined contact zone or area.

Another goal of the invention is to provide electrical contacts with a spring bushing with a reduced aluminum section, with the ability to withstand high rated-current density in the electrical contact portion.

Another goal of the invention is to provide electrical contacts with a spring bushing with a reduced aluminum section, which contacts are able to maintain low contact resistance for prolonged periods of time during stationary operation in the closed position.

Another goal of the invention is to provide electrical contacts with a spring bushing with a reduced aluminum section, in order to have sufficient flexibility resulting from the reduction of the cross-section of the aluminum of the contacts.

Another goal of the invention is to provide electrical contacts with a spring bushing with a reduced aluminum section, with the ability to withstand thermal shocks and electrodynamic forces during their exposure to short-circuit currents.

Another goal of the invention is to provide electrical contacts with a spring bushing with a reduced aluminum section, with the ability to prevent any risk of creating a meltdown between the contact and the facing part of the contact when the contact is subjected to a short circuit.

Another goal of the invention is to provide electrical contacts with a spring bushing with a reduced aluminum section, with equal contact force in the contact assembly for each contact element and/or extension.

Another goal of the invention is to provide electrical contacts with a spring bushing with a reduced aluminum section, with the ability to eliminate any movement of the contact (i.e., contact vibration) and any degradation of the contact caused by micro-arcing erosion.

Another goal of the invention is to provide electrical contacts with a spring bushing with a reduced aluminum section in order to distribute the force of the mechanical deformation of the aluminum through the reduced section, including spherical reductions, multiple spherical reductions, multiple angular reductions, and angular reductions.

Another goal of the invention is to provide electrical contacts with a spring bushing with a reduced aluminum section, with the ability to adapt to misalignment, thanks to the flexibility of the contacts provided in the reduced aluminum section.

These goals are achieved by providing a high-voltage switch with a perpendicular tubular installation of electrical contacts with a reduced aluminum section of the present invention, with useful contact pressure that can be calculated accurately, the area of physical interaction between the male cylindrical conductor and the tubular conductor, the contact area, and the form of the contact surface, which are all highly adaptable for misaligned assemblies; conservation of precise contact pressure, limited contact movement, high conductivity of the component materials, high efficiency in the elimination of oxides during the sliding movement, independent contact extensions, and the use of floating pressure distribution.

### DESCRIPTION OF THE INVENTION

Brief Description of the figures

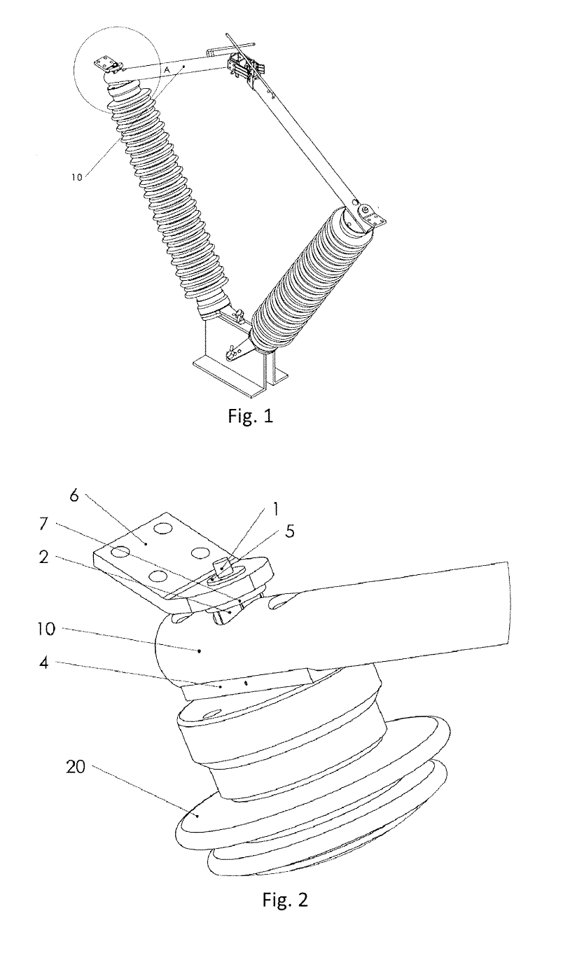

FIG. 1 is a perspective view of an ordinary switch in which the system according to the present invention is implemented, showing, in a circle, the details of the implementation.

FIG. 2 is a perspective view of the details shown in the circle in FIG. 1, showing the parts that constitute the system according to the present invention.

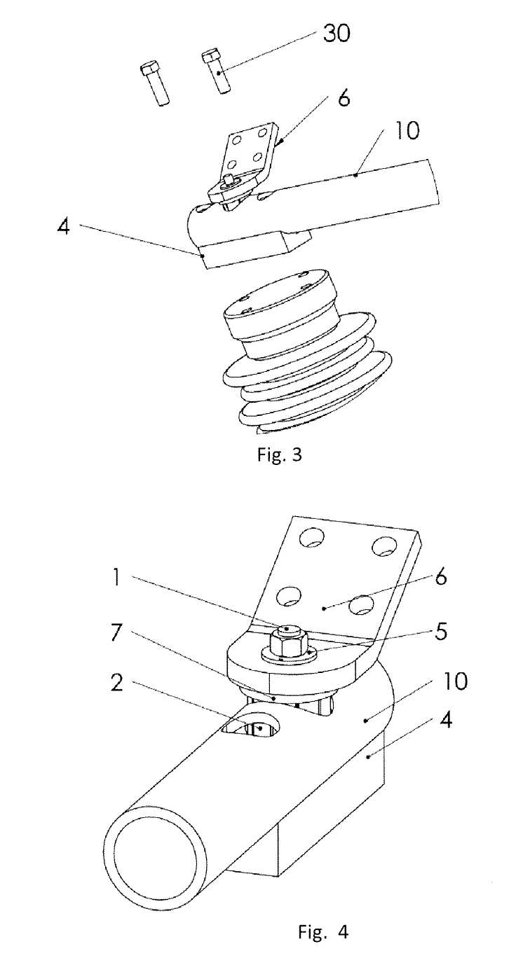

FIG. 3 is an exploded perspective view of the system according to the present invention.

FIG. 4 is a perspective view of the system according to the present invention, showing the major parts of the system.

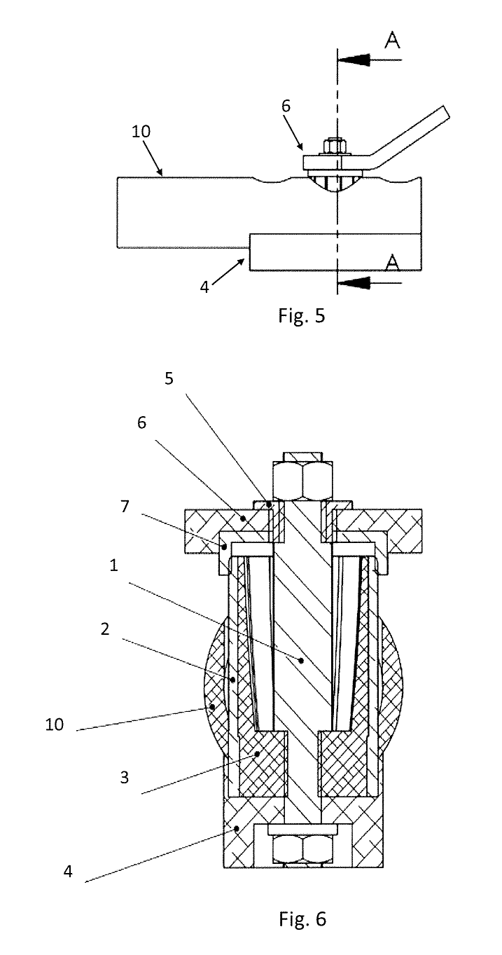

FIG. 5 is a side view of the system according to the present invention, showing the application of a cut in a section A-A.

FIG. 6 is a representative view of the cut in section A-A, as shown in FIG. 5, showing the internal components of the system.

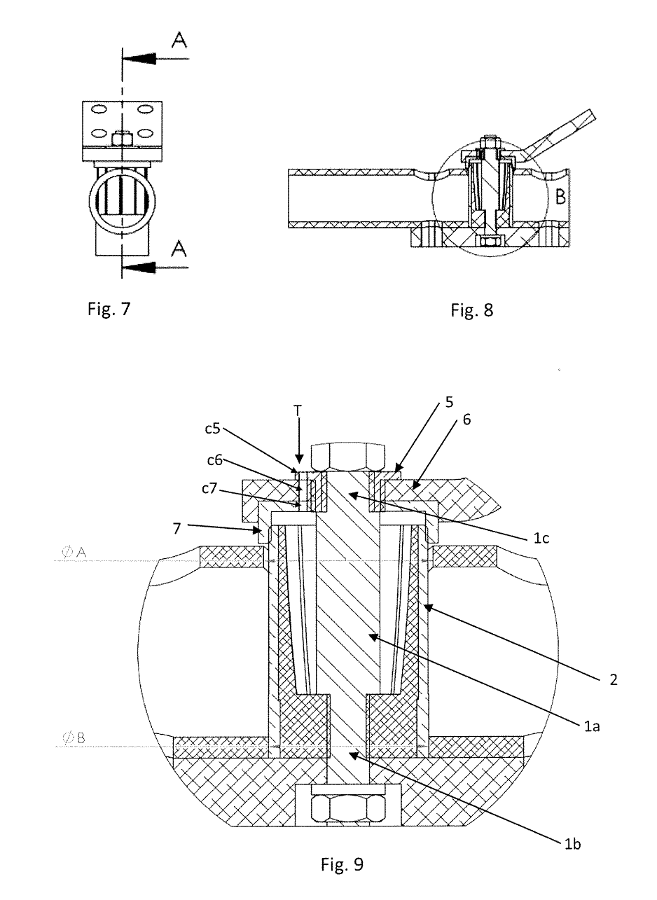

FIG. 7 is a front view of the system according to the present invention, showing the application of a cut in a section A-A.

FIG. 8 is a representative view of the cut in section A-A from FIG. 7, showing, in a circle B, the internal components of the system.

FIG. 9 is an enlarged view of the contents of the circle B from FIG. 8, showing the details of the internal components of the system.

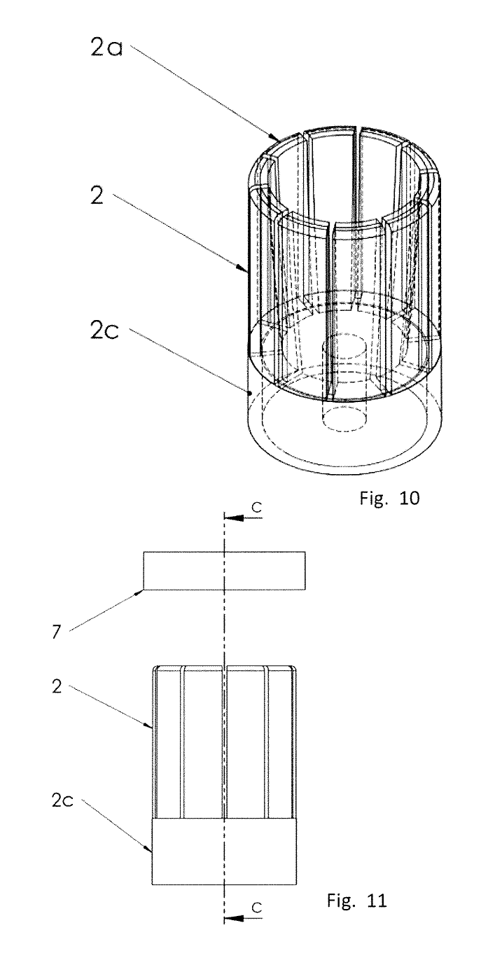

FIG. 10 is a perspective view of a spring bushing in the system according to the present invention, showing the fingers or extensions.

FIG. 11 is a side view of the spring bushing in conjunction with a female cylindrical conductor in the system according to the present invention, showing the application of a cut in a section C-C.

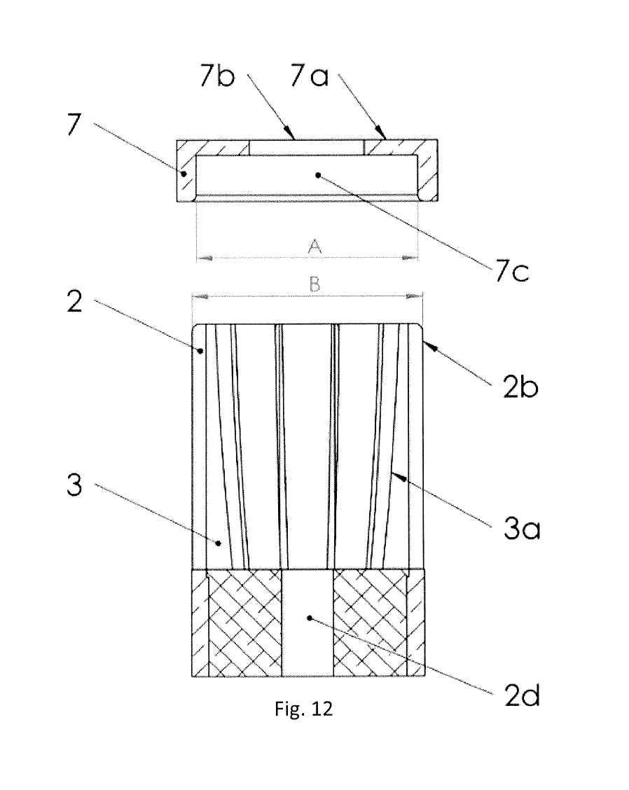

FIG. 12 is a representative view of the cut in section C-C from FIG. 11, showing in detail the internal components of the spring bushing in conjunction with a female cylindrical conductor.

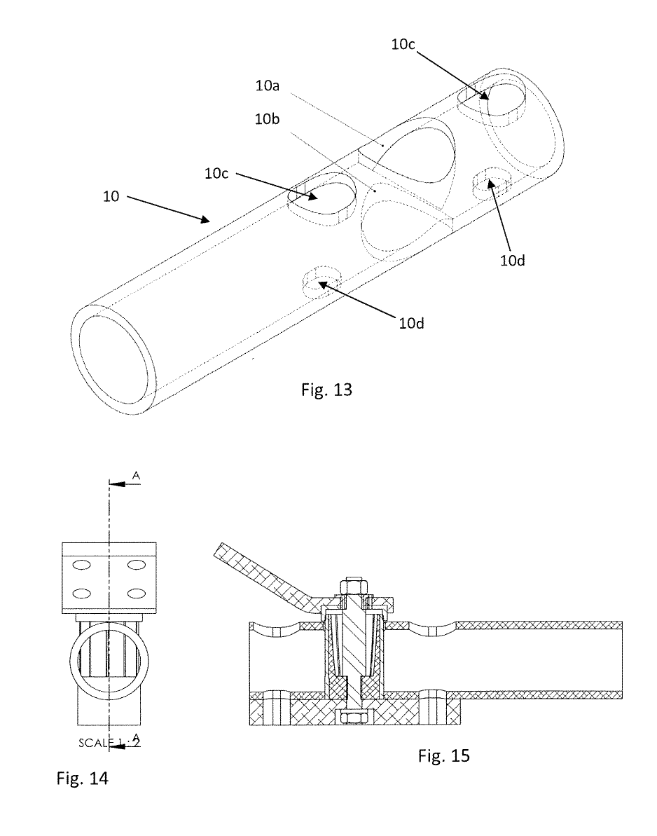

FIG. 13 is a representative view of a primary tubular conductor, showing in detail its constituent components.

FIG. 14 is a rear view of the system according to the present invention, showing the application of a cut in a section A-A.

FIG. 15 is a representative view of the cut in section A-A from FIG. 14, showing in detail the internal components of the system.

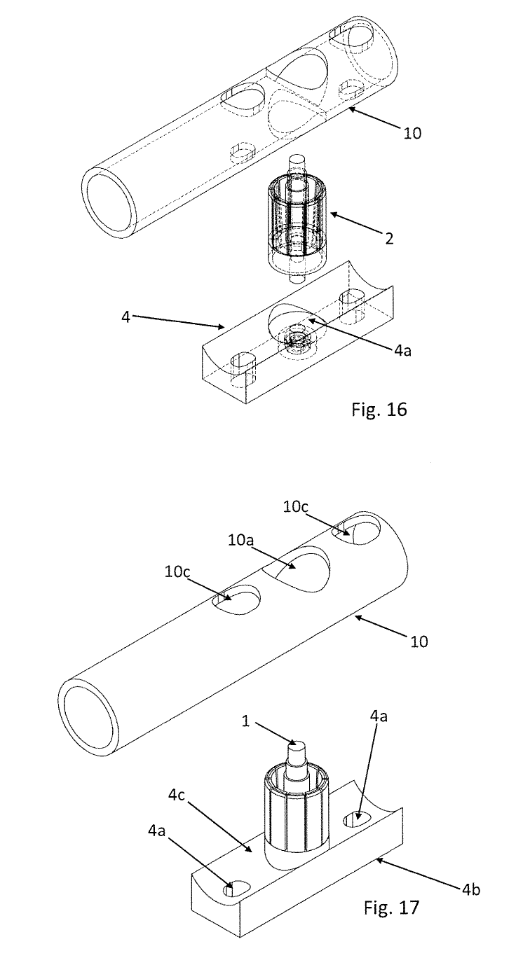

FIG. 16 is an exploded perspective view of certain components of the present invention.

FIG. 17 is an exploded perspective view of certain components of the present invention.

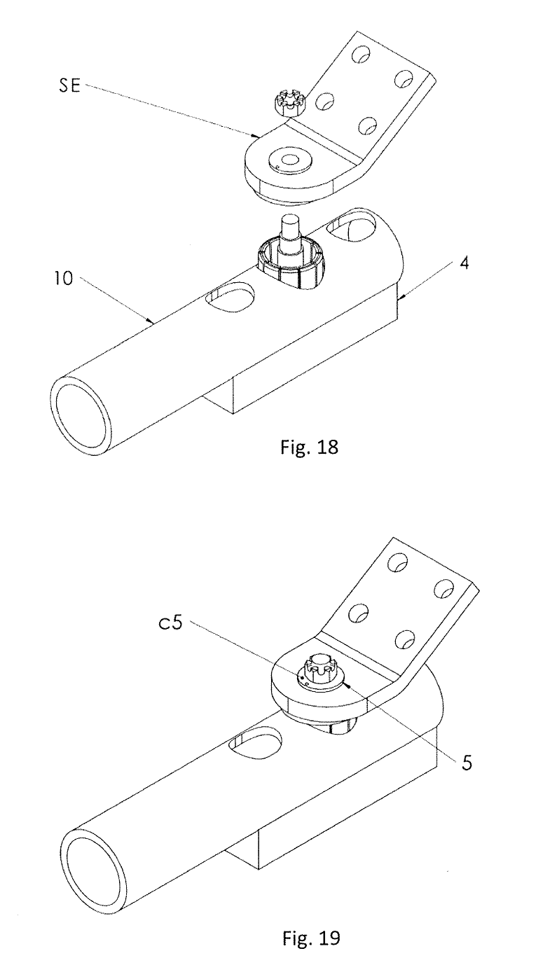

FIG. 18 is an exploded perspective view of a second assembly in relation to certain components of the present invention.

FIG. 19 is a perspective view of part of the system according to the present invention.

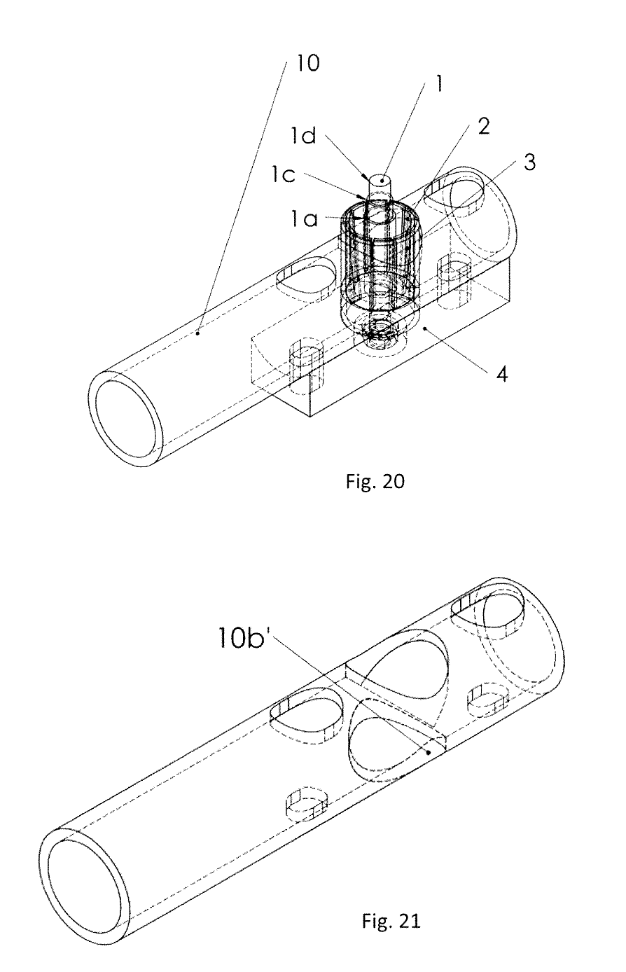

FIG. 20 is a perspective view of part of the system according to the present invention, showing the coupling with a primary fitting.

FIG. 21 is a perspective view of the primary tubular conductor, showing a coupling interface.

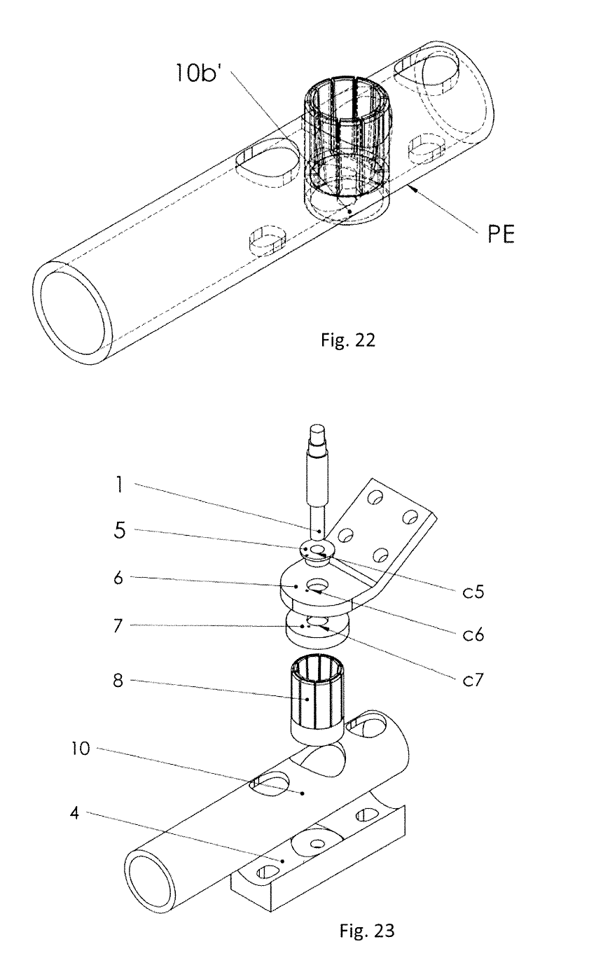

FIG. 22 is a perspective view of a first assembly consisting of a primary tubular conductor and a male cylindrical conductor, showing the coupling interface.

FIG. 23 is an exploded perspective view of the components of the present invention.

### DETAILED DESCRIPTION OF THE INVENTION

This invention relates to rotary contacts and to their incorporation into tubular conductors for use in movable switching assemblies. The movable contact systems according to this invention are designed to provide switching with a low number of interface contacts, low resistance, and low operating force. All of the elements of the contact assembly are designed to be produced by machining, extrusion, or stamping, and to provide an assembly with solder-free construction.

As shown in FIGS. 1 through 23, the system according to the present invention consists of a male cylindrical conductor (2) installed in a primary tubular conductor (10); a female cylindrical conductor (7) installed in a secondary conductor (6), which is the contact plate and which may also be tubular; a main pin (1); and two fittings (4, 5), which hold the primary tubular conductor (10) and the female cylindrical conductor (7) in place, as shown more clearly in FIGS. 2 and 3. As shown in FIG. 6, the main pin (1), the male cylindrical conductor (2), and the primary tubular conductor (10) are fixed in relation to each other.

As shown in FIG. 9, the secondary fitting (5) consists of a perforated bushing (5a) that has an upper edge, and that includes a stop that extends diametrically outward from an upper edge of the bushing, with the stop having a keyway (c5) that consists of a hole that passes through the wall of the stop.

The female cylindrical conductor (7) and the secondary conductor (6) are fixed in relation to each other, and are movable in relation to the main tubular conductor (10). The expected path of the electrical current runs from the primary tubular conductor (10) to the male cylindrical conductor (2) and to the female cylindrical conductor (7).

As shown more clearly in FIGS. 3, 4, and 13, which represent part of the overall length of the tubular conductor shown in FIG. 1, the primary tubular conductor (10), which forms part of a high-voltage electrical switch, has a first end and a second end, with the first end being coupled to an isolator (20), with the said first end including, in its upper part, an upper cylindrical opening (10a) that generates a free space, as well as a lower cylindrical opening (10b) that generates a free space, both of which coincide axially, and through which passes the male cylindrical conductor (2); two upper assembly holes (10c), each of which is located on one side of the upper cylindrical opening (10a), and whose function is to allow the free passage of two mounting screws (30). The primary tubular conductor (10) also includes two lower assembly holes (10d), which are oval and which coincide axially with the two upper assembly holes (10c). As shown in FIG. 3.2, the diameter (A) of the free space of the upper cylindrical opening (10a) is larger than the diameter (B) of the free space of a lower cylindrical opening (10b).

As shown in FIGS. 10 through 13, the male cylindrical conductor (2) is made from a tubular copper extrusion with a tubular wall that has a lower section (2c) that includes an internal coupling space (2d) and an upper section of its height that is grooved, so as to form a plurality of fingers or extensions (2a) that have an upper coupling edge (2b) with a given diameter (B), and that provide an internal coupling space; located within the said internal coupling space is a spring bushing (3) that has a reduced aluminum section (3a), with the spring bushing (3) having the same plurality of fingers, which coincide with the plurality of the fingers (2a) of the male cylindrical conductor (2).

The function of the upper coupling edge (2b) is to receive the female cylindrical conductor (7), which is made from a copper extrusion and which has an upper surface (7a) consisting of a wall having a given thickness, with a central upper opening (7b) and a hollow internal space (7c) that provides a free space whose function is to receive the male cylindrical conductor (2), because its diameter (A) is smaller than the diameter (B) of the upper coupling edge (2b) of the male cylindrical conductor (2). The female cylindrical conductor (7) also includes a keyway (c7) consisting of a hole that passes through the entire thickness of the upper surface (7a) of the said female cylindrical conductor (7).

As mentioned earlier, the diameter (B) of the male cylindrical conductor (2) is larger than the diameter (A) of the female cylindrical conductor (7). After the insertion of the male cylindrical conductor (2) into the female cylindrical conductor (7), pressure is applied by means of the elastic deformation of the spring bushing (3) with a reduced aluminum section.

As shown in FIGS. 20 and 22, the electrical contact between the primary tubular conductor (10) and the male cylindrical conductor (2) occurs along an outer perimeter of the full lower section (2c) of the male cylindrical conductor (2), which is pressure-fitted to the lower cylindrical opening (10b) in the primary tubular conductor (10), by means of a compressed grooved contact interface (10b′) formed in tubular wall of the primary tubular conductor (10), such that the primary tubular conductor (10) and the male cylindrical conductor (2) jointly form a first assembly (PE).

The electrical contact between the primary tubular conductor (10) and the male cylindrical conductor (2) may also be made by means of a threaded surface.

The secondary conductor (6) of the second assembly is a contact plate having a given thickness. It includes a lower cylindrical free space and a central opening whose diameter is smaller than the diameter of the central opening, and also includes a keyway (c6) consisting of a hole that passes through the entire thickness of the secondary conductor (6). The function of the lower cylindrical free space of the said secondary conductor (6) is to receive the female cylindrical conductor (7).

As shown in FIGS. 9, 18, and 22, once the first assembly of the system has been completed, the keyway (c5) of the secondary fitting (5), the keyway (c6) of the secondary conductor (6), and the keyway (c7) of the female cylindrical conductor (7) are brought together so as to form collectively a stop keyway (T), whose function is to receive a key, which holds in position, adjacent to the secondary fitting (5), the secondary conductor (6) and the female cylindrical conductor (7), such that collectively they form a second assembly (SE) that holds the contact plate of the secondary conductor (6).

The diameter of the free space in the secondary conductor (6) is smaller than the outside diameter of the female cylindrical conductor (7). The electrical contact between the secondary conductor (6) and the female cylindrical conductor (7) may also be made by means of the compression of the grooved surface of the female cylindrical conductor (7) inside it. The openings in the primary conductor (10), in the secondary conductor (6), in the male cylindrical conductor (2), in the spring bushing (3) with a reduced aluminum section, in the female cylindrical conductor (7), and in the main pin (1) are all coaxial. This arrangement makes it possible to limit the path of the electrical current to the four constituent parts of the rotary assembly.

As shown in FIG. 9, the main pin (1) includes a main body (1a), an upper end, and a lower end, and its length is such that, when all of the elements of the movable contact system are joined, both the upper end and the lower end can be secured by means of a threaded nut. The lower end of the said main pin (1) has a first coupling shaft (1b) whose diameter is smaller than the diameter of the main body (1a). Its function is to be coupled to the internal coupling space (2d) of the male cylindrical conductor (2), and to pass through a lower wall of the primary tubular conductor (10) and the primary fitting (4). The upper end of the said main pin (1) has a second coupling shaft (1c) that extends from the main body (1a), with a diameter that is less than the diameter of the said main body (1a), and whose function is to hold the secondary conductor (6) and the female cylindrical conductor (7) in their place. The upper end of the said main pin (1) also includes a third coupling shaft (1d) that extends from the second coupling shaft (1c), with a diameter that is less than the diameter of the said second coupling shaft (1c), and whose function is to secure, by means of a threaded nut, the secondary conductor (6) and the female cylindrical conductor (7).

The male cylindrical contact (2) and the primary tubular conductor (10) are held together by the main pin (1), which passes through the reduced aluminum section of the spring bushing (3) and the primary fitting (4). The female cylindrical conductor (7) is held in place by the secondary fitting (5), whose function is to serve as a rotation guide for the system, and which passes through the secondary conductor (6) and the female cylindrical conductor (7). The primary and secondary conductors are held in place by means of the main pin (1).

As shown in FIGS. 16 and 17, the primary fitting (4) is made from an aluminum extrusion that has a flat lower surface (4b) and an oval upper surface (4c), which coincides with the diameter of the primary tubular conductor (10). The primary fitting (4) has two oval holes (4d) whose function is to secure the contact assembly to an isolator (20) and to allow a certain amount of linear movement for the adjustment of the assembly in its final position. The oval upper surface (4c) of the primary fitting (4) has a cylindrical free space (4a) whose diameter is the same as that of the free space of the lower cylindrical opening (10b) in the primary tubular conductor (10). The main pin (1) is installed through the primary fitting (4) and is screwed from a lower surface, compressing together the primary fitting (4), the male cylindrical conductor (2), and the spring bushing (3) with a reduced aluminum section (see FIG. 5).

Before being installed on the isolator (20), the primary tubular conductor (10) is held in place, by means of a compressed grooved contact interface (10b′), between the male cylindrical conductor (2) and the free space of the lower cylindrical opening (10b) in the primary tubular conductor (10). The contact assembly is installed on the isolator (20) by means of two mounting screws (30) that pass through the upper assembly holes (10c) of the main tubular conductor (10) and the lower assembly holes (10d).

In order for the outside diameter of the male cylindrical conductor (2) to match the inside diameter of the free space of the lower cylindrical opening (10b) in the primary tubular conductor (10), the rotary contacts may be installed directly in the primary tubular conductor (10), with the use of the groove as the interface of the main conductor for the transfer of the current.

The perpendicular installation of a tubular object inside another object that has a relatively similar diameter produces a broad surface for interaction between them, and provides a rotary assembly with a sufficient surface area for the transfer of the electric current.

The technical advantages of the present invention are that it:

1. Allows the adjustment of the entire contact area between the male cylindrical conductor (2) and the tubular conductor (10), through the selection of similar dimensions for the conductors.

2. Allows the use of unsoldered thin-walled tubular conductors.

3. Resolves an issue relating to the provision of pressure for rotating electrical contacts with extremely small dimensions.

4. Allows the adjustment of the entire operational force, through the accurate selection of the number of contact extensions and of the pressure value of each contact extension.

5. Allows the construction of rotary contact assemblies without the use of complex systems for the provision of additional pressure.

6. Allows the construction of a contact assembly through the use of materials with low relative magnetic permeability.

7. Provides a contact assembly with an electrically isolated pressure supply system. (The anodized aluminum creates a layer of aluminum oxide that possesses significant dielectric properties.)

8. The anodized aluminum surface makes it possible to provide an electrical contact assembly that has a high degree of resistance to salt air and resistance to the galvanic corrosion of the materials.

9. The construction of tubular extrusions makes it possible to produce electrical contact assemblies with minimal losses of material due to machining.

1. A rotary contact system intended to be incorporated into the tubular conductors of a high-voltage switch, which includes:
a main pin (1);
a first assembly (PE), consisting of a primary tubular conductor (10) and a male cylindrical conductor (2), in which the said primary tubular conductor (10) has a first end and a second end, with the first end being coupled to an isolator (20), with the said first end including, in its upper part, an upper cylindrical opening (10a) that generates a free space, as well as a lower cylindrical opening (10b) that generates a free space, both of which coincide axially, and through which passes the male cylindrical conductor (2), with the free space of the upper cylindrical opening (10a) having a diameter (A) that is greater than a diameter (B) of the free space of the lower cylindrical opening (10b); and
a second assembly (SE), consisting of a secondary fitting (5), a secondary conductor (6), and a female cylindrical conductor (7), with the said second assembly being coupled rotatively to the first assembly by means of the main pin (1).

2. A rotary contact system intended to be incorporated into the tubular conductors of a high-voltage switch, in accordance with claim 1, characterized in that the main pin (1) includes a main body (1a), an upper end, and a lower end, and whose length is such that, when all of the elements of the movable contact system are joined, both the upper end and the lower end can be secured by means of a threaded nut.

3. A rotary contact system intended to be incorporated into the tubular conductors of a high-voltage switch, in accordance with claim 2, characterized in that the main pin (1) includes, at its upper end, a second coupling shaft (1c) that extends from the main body (1a), with a diameter that is less than the diameter of the said main body (1a), and whose function is to hold the secondary conductor (6) and the female cylindrical conductor (7) in their place; the upper end of the said main pin (1) also includes a third coupling shaft (1d) that extends from the second coupling shaft (1c), with a diameter that is less than the diameter of the said second coupling shaft (1c), and whose function is to secure, by means of a threaded nut, the secondary conductor (6) and the female cylindrical conductor (7).

4. A rotary contact system intended to be incorporated into the tubular conductors of a high-voltage switch, in accordance with claim 1, characterized in that the primary tubular conductor (10) includes two upper assembly holes (10c), each of which is located on one side of the upper cylindrical opening (10a), and whose function is to allow the free passage of two mounting screws (30); the said primary tubular conductor (10) also includes two lower assembly holes (10d), which are oval and which coincide axially with the two upper assembly holes (10c).

5. A rotary contact system intended to be incorporated into the tubular conductors of a high-voltage switch, in accordance with claim 1, characterized in that the male cylindrical conductor (2) of the first assembly is made from a tubular copper extrusion with a tubular wall that has a lower section (2c) that includes an internal coupling space (2d) and an upper section of its height that is grooved, so as to form a plurality of fingers or extensions (2a) that have an upper coupling edge (2b) with a given diameter (B), and that provide an internal coupling space; located within the said internal coupling space is an spring bushing (3) that has a reduced aluminum section (3a), with the spring bushing (3) having the same plurality of fingers, which coincide with the plurality of the fingers (2a) of the male cylindrical conductor (2).

6. A rotary contact system intended to be incorporated into the tubular conductors of a high-voltage switch, in accordance with claim 1, characterized in that the electrical contact between the primary tubular conductor (10) and the male cylindrical conductor (2) is located on an outer perimeter of the complete lower section (2c) of the male cylindrical conductor (2) that is press-fitted to the lower cylindrical opening (10b) in the primary tubular conductor (10), by means of a compressed grooved contact interface (10b′) formed in the tubular wall of the primary tubular conductor (10).

7. A rotary contact system intended to be incorporated into the tubular conductors of a high-voltage switch, in accordance with claim 1, characterized in that the female cylindrical conductor (7) and the secondary conductor (6) of the second assembly are fixed in relation to each other, and are movable in relation to the primary tubular conductor (10) of the first assembly, and in which the expected path of the electrical current runs from the primary tubular conductor (10) to the male cylindrical conductor (2) and to the female cylindrical conductor (7).

8. A rotary contact system intended to be incorporated into the tubular conductors of a high-voltage switch, in accordance with claim 1, characterized in that the secondary fitting (5) consists of a perforated bushing (5a) that has an upper edge, and that includes a stop (5b) that extends diametrically outward from an upper edge of the bushing, with the stop (5b) having a keyway (c5) that consists of a hole that passes through the wall of the stop (5b).

9. A rotary contact system intended to be incorporated into the tubular conductors of a high-voltage switch, in accordance with claim 1, characterized in that the secondary conductor (6) of the second assembly is a contact plate having a given thickness; the secondary conductor includes a lower cylindrical free space and a central opening whose diameter is smaller than the diameter of the central opening, and also includes a keyway (c6) consisting of a hole that passes through the entire thickness of the secondary conductor (6); and the function of the lower cylindrical free space of the said secondary conductor (6) is to receive the female cylindrical conductor (7).

10. A rotary contact system intended to be incorporated into the tubular conductors of a high-voltage switch, in accordance with claim 1, characterized in that the female cylindrical conductor (7), which is made from a copper extrusion, with an upper surface (7a) consisting of a wall having a given thickness, with a central upper opening (7b) and a hollow internal space (7c) that provides a free space whose function is to receive the male cylindrical conductor (2), because its diameter (A) is smaller than the diameter (B) of the upper coupling edge (2b) of the male cylindrical conductor (2); in which the female cylindrical conductor (7) also includes a keyway (c7) consisting of a hole that passes through the entire thickness of the upper surface (7a) of the said female cylindrical conductor (7).

11. A rotary contact system intended to be incorporated into the tubular conductors of a high-voltage switch, in accordance with claim 8, 9, and 10, characterized in that the keyway (c5) of the secondary fitting (5), the keyway (c6) of the secondary conductor (6), and the keyway (c7) of the female cylindrical conductor (7) collectively form a stop keyway (T), whose function is to receive a key, which holds in position, adjacent to the secondary fitting (5), the secondary conductor (6) and the female cylindrical conductor (7), such that collectively they form the second assembly that holds the contact plate of the secondary conductor (6).

12. A rotary contact system intended to be incorporated into the tubular conductors of a high-voltage switch, in accordance with any of the foregoing claims, characterized in that it includes a primary fitting (4) that is made from an aluminum extrusion that has a flat lower surface (4b) and an oval upper surface (4c), which coincides with the diameter of the primary tubular conductor (10); the said primary fitting (4) has two oval holes (4d) whose function is to secure the contact assembly to an isolator (20) and to allow a certain amount of linear movement for the adjustment of the assembly in its final position; in which the oval upper surface (4c) of the primary fitting (4) has a cylindrical free space (4a) whose diameter is the same as that of the free space of the lower cylindrical opening (10b) in the primary tubular conductor (10); and in which the main pin (1) is installed through the primary fitting (4) and is screwed from a lower surface, compressing together the primary fitting (4), the male cylindrical conductor (2), and the spring bushing (3) with a reduced aluminum section.

13. A rotary contact system intended to be incorporated into the tubular conductors of a high-voltage switch, in accordance with claim 8, characterized in that the female cylindrical conductor (7) is held in place by the secondary fitting (5), whose function is to serve as a rotation guide for the system, and which passes through the secondary conductor (6) and the female cylindrical conductor (7).

14. A rotary contact system intended to be incorporated into the tubular conductors of a high-voltage switch, in accordance with claim 4, characterized in that the contact assembly is installed on the isolator (20) by means of two mounting screws (30) that pass through the upper assembly holes (10c) of the primary tubular conductor (10) and the lower assembly holes (10d).
